(19) United States
(12) Patent Application Publication
(10) Pub. No.: US 2006/0286919 A1
(43) Pub. Date: Dec. 21, 2006

(54) Door actuator having dual output shaft for air conditioner of automotive vehicles

(75) Inventors: Gyuik Han, Daejeon-si (KR); Jaehoon Lee, Daejeon-si (KR)

Correspondence Address: HARNESS, DICKEY & PIERCE, P.L.C., P.O. BOX 828, BLOOMFIELD HILLS, MI, 48303, US

(73) Assignee: Halla Climate Control Corporation, Daejeon-si (KR)

(21) Appl. No.: 11/452,177

(22) Filed: Jun. 13, 2006

(30) Foreign Application Priority Data
Jun. 13, 2005 (KR) 2005-50313

(51) Int. Cl. B60H 1/24

(52) U.S. Cl. 454/162

(57) ABSTRACT

The present invention relates to a door actuator having a dual output shaft for an air conditioner of a vehicle, which includes a modulated feedback sensor having a hollow and fit to one of two output shafts of an output gear through the hollow for recognizing and controlling a feedback output value without using a circuit board, thereby minimizing deterioration of quality caused by soldering, reducing the number of parts, and minimizing an operational error. The door actuator includes: upper and lower covers (100, 120) coupled with each other; a motor (140) mounted inside the coupled upper and lower covers; an output gear (160) connected to a driving gear (142) mounted on a shaft of the motor through an array of reduction gears (150), the output gear (160) having a pair of output shafts (162, 164) formed on both sides thereof and drawn out through the upper and lower covers; and a modulated feedback sensor (170) having a hollow (172) and fit to one of the output shafts for recognizing and controlling a feedback output value according to a rotation of the output gear.

### BACKGROUND OF THE INVENTION

1. Field of the Invention

The present invention relates to a door actuator having a dual output shaft for an air conditioner of a vehicle, and more particularly, to a door actuator having a dual output shaft for an air conditioner of a vehicle, which includes a modulated feedback sensor having a hollow and fit to one of two output shafts of an output gear through the hollow for recognizing and controlling a feedback output value without using a circuit board, thereby minimizing deterioration of quality caused by soldering, reducing the number of parts, and minimizing an operational error.

2. Background Art

As shown in FIG. 1, an air conditioner of a vehicle includes an air blast (not shown), an air conditioning case (1) connected to the air blast, and an evaporator (E) and a heater core (H) embedded in the air conditioning case (1). The evaporator (E) is connected with systems constituting a cooling cycle, and the heater core (H) is connected with systems constituting a heating cycle. That is, when the cooling cycle is operated, air blown by the air blast is exchanged thermally and changed into cool air while passing through the evaporator (E). After that, the cool air is discharged to the inside of the vehicle so as to make the inside of the vehicle cool. Moreover, when the heating cycle is operated, the operation of the cooling cycle is stopped, and air blown by the air blast is exchanged thermally and changed into hot air while passing through the heater core (H). After that, the hot air is discharged to the inside of the vehicle so as to make the inside of the vehicle hot.

To adjust an air volume, temperature, and the direction of the wind toward the inside of the vehicle, as shown in FIG. 1, a number of doors, such as an air intake door (not shown) for selectively determining intake of indoor air/outdoor air, a temp door 5 for determining a flow rate passing through the heater core (H) and a flow rate bypassing the heater core (H), and a number of mode doors 2, 3 and 4 for determining modes such as face, defrost, floor, mix, bi-level etc. are mounted on the air conditioner.

The doors may be operated manually. When a user manipulates a corresponding switch inside the vehicle, the doors are operated through a cable connected to the switch and a lever for connecting the cable and the doors.

Moreover, in case of a high-grade vehicle having an automatic temperature controller, as shown in FIG. 2, a door actuator 7 operated by an output signal of a control unit is mounted on the outer periphery of the air conditioning case 1 in such a way as to be directly mounted on a shaft of the door or to be connected to the air conditioning case 1 by interposition of the lever, whereby the doors can be automatically feedback-controlled.

The door actuators are classified into two kinds: one having a single output shaft, and the other having a dual output shaft. The door actuator having the dual output shaft has been disclosed for the purpose of minimization of right and left temperature difference in a right and left independent air conditioner, reduction of man hour when it is manufactured for an RHD (Right Handle Drive) vehicle, reduction of manufacturing costs through commonness of a bracket.

A representative example of the door actuator having the dual output shaft is disclosed in Korean Utility Model Registration No. 275334 and shown in FIG. 3.

The door actuator includes: upper and lower covers 10a and 10b coupled with each other; a motor 11 mounted inside the upper and lower covers 10a and 10b; an output gear 16 connected with a driving gear 12 mounted on a shaft of the motor 11 through an array of reduction gears (G), and having a pair of output shafts formed on both sides thereof and drawn out through the upper and lower covers 10a and 10b; a printed circuit board 18 having a resistance pattern printed thereon and mounted on the lower cover 10b; a wiper 17 for recognizing and controlling a feedback output value by controlling resistance of the resistance pattern according to rotation of the output gear 16. Meanwhile, in stead of the wiper 17, carbon may be coated on a side of the output gear 16.

However, in such door actuator having the above configuration, the printed circuit board 18 must be mounted on the lower cover 10b by soldering. So the door actuator has several disadvantages in that the soldered portion may cause deterioration of quality since the soldered portion may be come off, in that the resistance pattern and the wiper 17 (or carbon) may be worn away by friction force, in that a resistance value may be changed, and in that introduction of foreign matters may cause malfunction of the door actuator.

Meanwhile, FIG. 4 shows another example of the door actuator having the dual output shaft. The door actuator further includes: a position controlling reduction gear (40) located in an array of reduction gears for transmitting rotational power of a motor (not shown), the reduction gear (40) being mounted on an output gear 30 having a pair of output shafts 32 and 34 drawn out through upper and lower covers 20 and 22; and a feedback sensor 50 inserted into the circumference of a shaft 42 of the position controlling reduction gear 40 and fixed on the lower cover 22 so as to recognize and control a feedback output value.

However, since the door actuator shown in FIG. 4 additionally includes the position controlling reduction gear 40, it is disadvantageous to increase its weight and manufacturing price, and to increase a size of the door actuator as big as the space where the position controlling reduction gear 40 occupies in the door actuator. Furthermore, the door actuator may increase an error in measurement since rotation of the output shafts 32 and 34 is measured through the reduction gear 40.

### SUMMARY OF THE INVENTION

Accordingly, to solve the above disadvantages of the prior arts, it is an object of the present invention to provide a door actuator having a dual output shaft for an air conditioner of a vehicle, which includes a modulated feedback sensor having a hollow and fit to one of two output shafts of an output gear through the hollow for recognizing and controlling a feedback output value without using a circuit board, thereby minimizing deterioration of quality caused by soldering, reducing the number of parts, and minimizing an operational error.

To accomplish the above objects, according to the present invention, there is provided a door actuator having a dual output shaft for an air conditioner of a vehicle including: upper and lower covers coupled with each other; a motor mounted inside the coupled upper and lower covers; an output gear connected to a driving gear mounted on a shaft of the motor through an array of reduction gears, the output gear having a pair of output shafts formed on both sides thereof and drawn out through the upper and lower covers; and a modulated feedback sensor having a hollow and fit to one of the output shafts for recognizing and controlling a feedback output value according to a rotation of the output gear.

Additionally, the upper output shaft is a female output shaft having a coupling hole and the lower output shaft is a male output shaft, and the feedback sensor is fit to the lower output shaft.

Furthermore, the outer diameter of the lower output shaft is smaller than that of the upper output shaft.

Moreover, a connection terminal for arranging the lead wires drawn out from the feedback sensor therein includes: a terminal forming portion formed on a side of the upper cover; and another terminal forming portion formed on a side of the lower cover, the terminal forming portions being matched in shape with each other so as to form the connection terminal.

In addition, a number of mounting brackets, which will be mounted on the air conditioner, are formed along the side circumference of the upper cover and a number of mounting brackets, which will be mounted on the air conditioner, are formed along the side circumference of the lower cover corresponding to the mounting brackets.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a sectional view showing a conventional air conditioner for a vehicle;

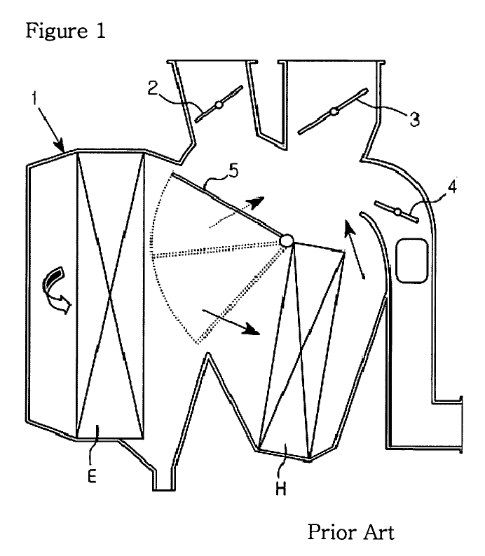

FIG. 2 is a partially perspective view showing an example that a door actuator is mounted on an air conditioning case of the air conditioner;

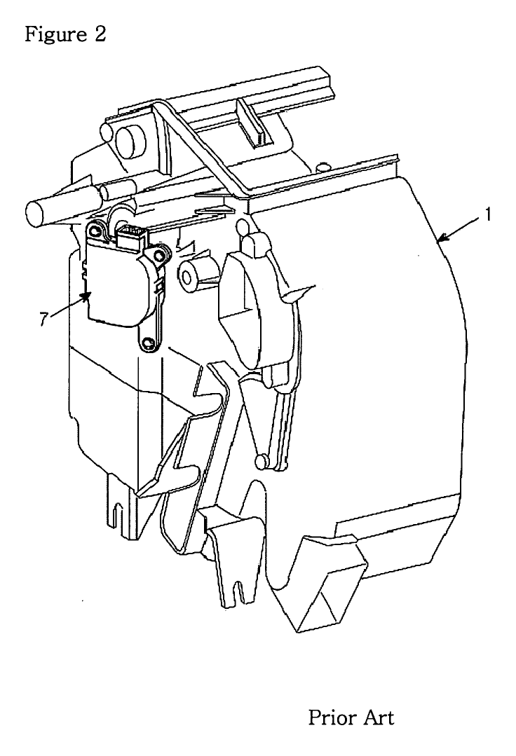

FIG. 3 is an exploded perspective view showing an example of a conventional door actuator having a dual output shaft for an air conditioner of a vehicle;

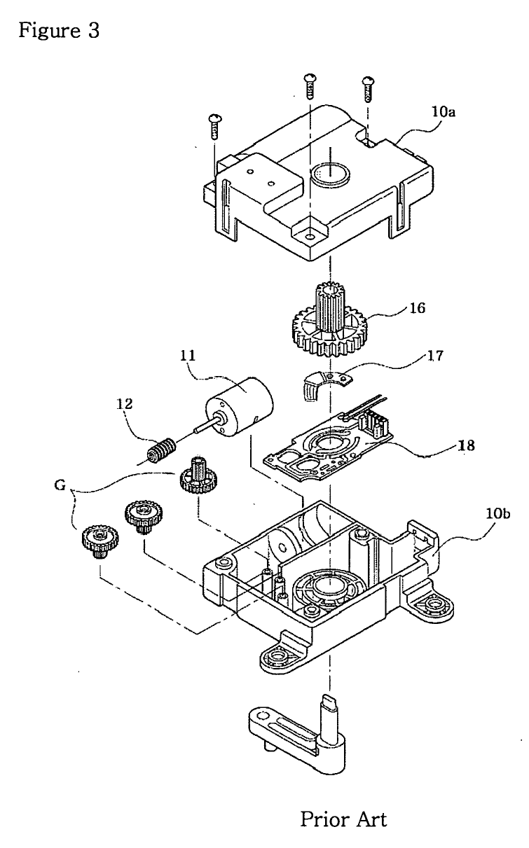

FIG. 4 is a partially sectional view showing another example of a conventional door actuator having a dual output shaft for an air conditioner of a vehicle;

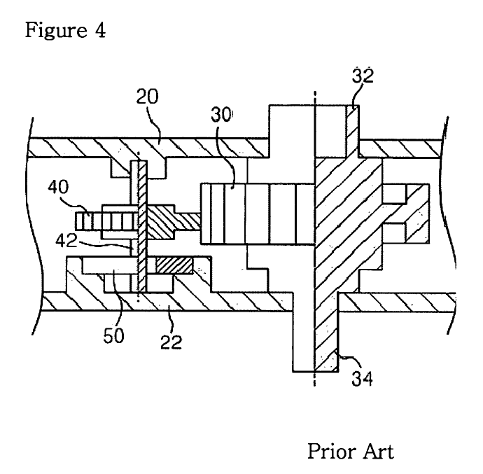

FIG. 5 is an exploded perspective view showing a door actuator having a dual output shaft for an air conditioner of a vehicle according to the present invention; and

FIG. 6 is a perspective view showing the door actuator having the dual output shaft for the air conditioner according to the present invention.

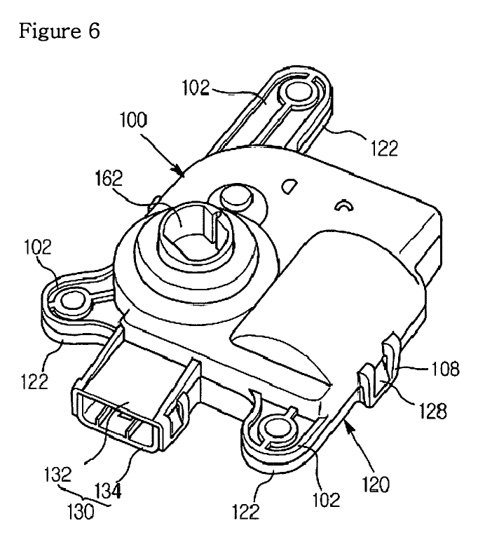

### DETAILED DESCRIPTION OF THE PREFERRED EMBODIMENT

Reference will be now made in detail to the preferred embodiment of the present invention with reference to the attached drawings. Words and terms in this specification and claims shall be interpreted into meaning and concept corresponding to technical conception of the present invention based on the principle that an inventor can properly define terms to explain and describe an invention in the best way.

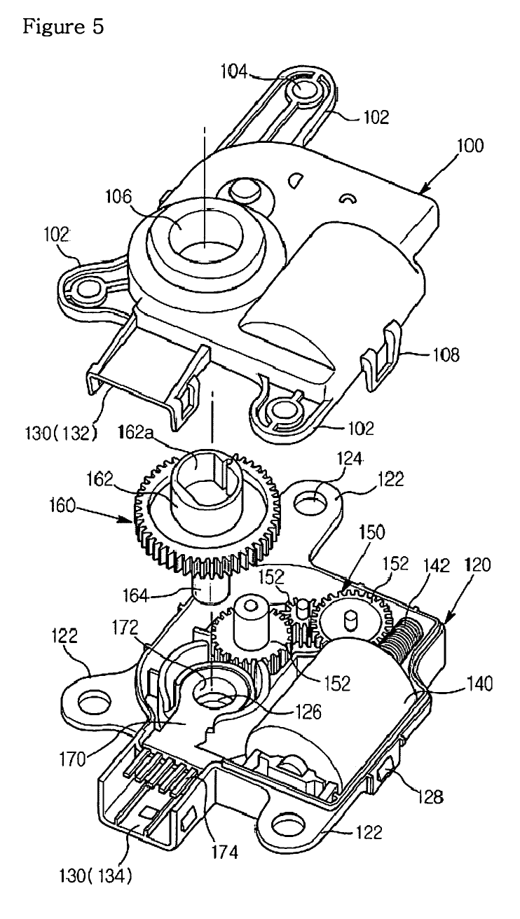

FIG. 5 is an exploded perspective view showing a door actuator having a dual output shaft for an air conditioner of a vehicle according to the present invention.

The door actuator according to the present invention includes upper and lower covers 100 and 120, a motor 140, an output gear 160, and a feedback sensor 170.

The upper and lower covers 100 and 120 are vertically coupled with each other, and the coupled covers 100 and 120 form a predetermined space therein for mounting the motor 140, the output gear 160 and the feedback sensor 170 therein.

The motor 140 is mounted in the space formed between the upper and lower covers 100 and 120, and driven forward and backward according to an output signal of a control unit (not shown).

A driving gear 142 is mounted on a shaft of the motor 140, and for example, a worm gear may be adopted as the driving gear 142. The driving gear 142 transmits driving force to the output gear 160 through an array of reduction gears 150 having a number of reduction gears 152 after decreasing the driving force. A spur gear may be adopted as the reduction gear 152.

According to the present invention, the output gear 160 includes an upper output shaft 162 and a lower output shaft 164 drawn out through the upper and lower covers 100 and 120. It is preferable that the upper output shaft 162 is a female output shaft having a coupling hole 162a and the lower output shaft 164 is a male output shaft. Moreover, it is preferable that the outer diameter of the lower output shaft 164 is smaller than that of the upper output shaft 162.

Furthermore, the feedback sensor 170 has a modulated variable resistance portion embedded therein for recognizing a feedback output value and controlling a forward/backward rotation angle of the output gear 160 according to the rotation of the output gear 160. The feedback sensor 170 further includes a hollow 172, and lead wires 174 drawn to a side thereof. The feedback sensor 170 is fixed on the lower cover 120 after being fit to one of the output shafts 162 and 164, for example, to the lower output shaft 164 of the smaller outer diameter, through the hollow 172.

Meanwhile, it is preferable that a connection terminal 130 for arranging the lead wires 174 drawn out from the feedback sensor 170 therein includes: a terminal forming portion 132 formed on a side of the upper cover 100; and another terminal forming portion 134 formed on a side of the lower cover 120 corresponding to the terminal forming portion 132. The terminal forming portions 132 and 134 are matched in shape with each other so as to form the connection terminal 130.

In addition, it is preferable that a number of first mounting brackets 102 are formed along the side circumference of the upper cover 100 and a number of second mounting brackets 122 are formed along the side circumference of the lower cover 100 corresponding to the first mounting brackets 102. The mounting brackets 102 and 122 respectively have coupling holes 104 and 124 individually corresponding with each other, so that the mounting brackets 102 and 122 are in contact with each other when the upper and lower covers 100 and 120 are coupled with each other. Therefore, the door actuator of the present invention can be mounted in a proper place of the air conditioner of the vehicle through the coupling holes 104 and 124 via coupling means such as bolts.

The reference numeral 106 in FIG. 5 designates a shaft hole formed on the upper cover 100 to allow the upper output shaft 162 to be drawn out as shown in FIG. 5, and the reference numeral 126 designates a shaft hole formed on the lower cover 120 to allow the lower output shaft 164 to be drawn out. Moreover, the reference numeral 108 designates a number of clips formed sides of the upper cover 100, and the reference number 128 designates a number of holding jaws formed sides of the lower cover 120, whereby the clips 108 are separably combined to the holding jaws as shown in FIG. 5 so as to separably couple the upper and lower covers 100 and 120.

Next, the operation of the door actuator for the air conditioner of the vehicle having the dual output shaft according to the present invention will be described.

The door actuator according to the present invention may be connected to an air intake door of an air blast for controlling intake of indoor air/outdoor air in the air conditioner, connected to a temp door for controlling temperature of air, or connected to a vent door for controlling a direction of wind to the inside of the vehicle.

Meanwhile, the structure and installation position of the air conditioner are changed according to the position of a steering handle. Also in this case, the door actuator of the present invention includes a pair of the output shafts 162 and 164 drawn out bi-directionally, the mounting brackets 102 and 122 integrated to the upper and lower covers 100 and 120, and the connection terminals 130 mounted at the circumference of the sides of the upper and lower covers 100 and 120, whereby the door actuator can be mounted at the right or left side of the air conditioner with no changes of the structure and the parts thereof.

The modulated feedback sensor 170 is directly connected to the lower output shaft 164 through the hollow 172 and fixed on the lower cover 120, whereby an angle error of the feedback sensor 170 to the output shafts 162 and 164 can be minimized and the number of parts can be reduced since additional parts, such as a position controlling reduction gear or a printed circuit board, are not needed.

As described above, the door actuator for the air conditioner according to the present invention can increase mounting efficiency since one of the output shafts 162 and 164 can be mounted at the right or left side of the air conditioner without changes of the structure and the parts thereof.

Moreover, the door actuator according to the present invention can exactly control the doors of the air conditioner since the angle error of the feedback sensor 170 to the output shafts 162 and 164 can be minimized by directly connecting the modulated feedback sensor 170 to the lower output shaft 164 through the hollow 172 and fixing it on the lower cover 120.

Furthermore, the door actuator according to the present invention can reduce the number of parts and manufacturing costs since it does not need the position controlling reduction gear or the printed circuit board due to the modulated feedback sensor 170.

In addition, the door actuator can minimize deterioration of quality since it does not need the printed circuit board and soldering work for mounting the printed circuit board.

Additionally, the door actuator according to the present invention can simplify its structure due to the mounting brackets 102 and 122 integrated to the upper and lower covers 100 and 120.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A door actuator having a dual output shaft for an air conditioner of a vehicle comprising:
upper and lower covers coupled with each other;
a motor mounted inside the coupled upper and lower covers;
an output gear connected to a driving gear mounted on a shaft of the motor through an array of reduction gears, the output gear having a pair of output shafts formed on both sides thereof and drawn out through the upper and lower covers; and
a modulated feedback sensor having a hollow and fit to one of the output shafts for recognizing and controlling a feedback output value according to a rotation of the output gear.

2. A door actuator according to claim 1, wherein the upper output shaft is a female output shaft having a coupling hole and the lower output shaft is a male output shaft, and the feedback sensor is fit to the lower output shaft.

3. A door actuator according to claim 2, wherein the outer diameter of the lower output shaft is smaller than that of the upper output shaft.

4. A door actuator according to claim 1, wherein a connection terminal for arranging the lead wires drawn out from the feedback sensor therein is formed on side circumferences of the upper and lower covers.

5. A door actuator according to any one of claims 1 to 4, wherein a number of mounting brackets, which will be mounted on the air conditioner, are correspondently formed along the side circumferences of the upper and lower covers.
